(19) United States
(12) Patent Application Publication
(10) Pub. No.: US 2004/0181902 A1
(43) Pub. Date: Sep. 23, 2004

(54) Gate-mate

(76) Inventors: Danny Joe Pierce, Bloomington, IN (US); Joseph Allen Roberts, Bloomington, IN (US); Karen Jean Pierce, Bloomington, IN (US); Gina Suzette Roberts, Bloomington, IN (US)

Correspondence Address: Karen Pierce, PI-RO MFG. L.L.C., P.O. Box 164, Clear Creek, IN, 47426, US

(21) Appl. No.: 10/391,288

(22) Filed: Mar. 18, 2003

(51) Int. Cl. E05F 3/00

(52) U.S. Cl. 16/49

(57) ABSTRACT

The invention is an apparatus that is used to hold a gate in an open position, once it has been opened. When the apparatus is mounted to the frame of a gate, and placed in the downward position, the gate stop device ensures the gate will remain in this open position. The gate stop device while in use, and the gate is in the open position eliminates the unwanted closure of the gate.

### BACKGROUND OF THE INVENTION

This invention is unique, because there is no know product to accommodate the need that the Gate-Mate provides. The Gate-Mate is a device, which attaches to the frame of a gate. Once the gate is opened, the device is placed in the downward position enabling the gate to remain in the open position until you are ready to close it. After doing a patent search via the USPTO website no other device was found that would accommodate this need.

Before the prescribed time there has been no successful device to accommodate this need. If someone needed to keep a gate open a rock or stick most commonly is used, not only does this prove to be unsuccessful, it also does not eliminate the element of danger of the gate closing without warning. After eighteen years of working daily in a field of employment where there is a constant need for gates to remain open until ready for closure, it results in numerous occurrences of personal injury, and or property damage as a result of a gate closing without prior warning, and a lack of a successful product existing. This product eliminates the above described problems.

### SUMMARY OF THE INVENTION

The Gate-Mate device is to be attached to the frame of a gate. When the gate is in any open position, and the device is placed in the downward position the device allows the gate to remain open until you choose to close it.

The advantage, and object of this device is to provide a safe successful method in which to hold a gate open in any position. This device eliminates the sudden closure of a gate without prior warning thus reducing personal injury, and property damage.

The advantage, and object of the device will become easy to see from the following brief description of the drawings, and understood when read in connection with the detailed description of the drawings.

### BRIEF DESCRIPTION OF THE DRAWINGS

FIG. 1 is a front view of the Gate-Mate device as it would appear when attached to a gate, and not in use.

FIG. 2 is an exploded view of the Gate-Mate device, and all parts required for assembly, and mounting.

FIG. 3 is showing three different views with three different angles. The first (1^{st}) view shows the Gate-Mate device from the front as it would appear attached to a gate, but not in use. The second (2^{nd}) view shows the Gate-Mate device from the side as it would appear attached to a gate, but not in use. The third (3^{rd}) view shows the Gate-Mate device from the front as it would appear attached to a gate, and in use.

### DETAILED DESCRIPTION OF THE DRAWINGS

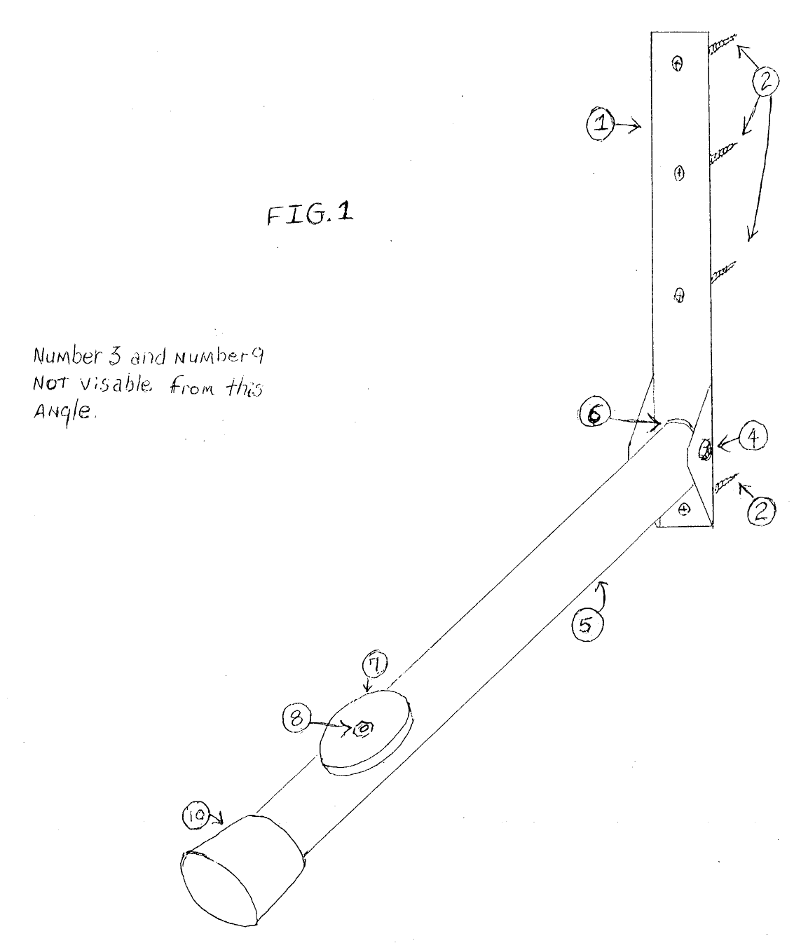

IN FIG. 1 The Gate-Mate device assembled, but not attached to a gate, and in the position as if in use.

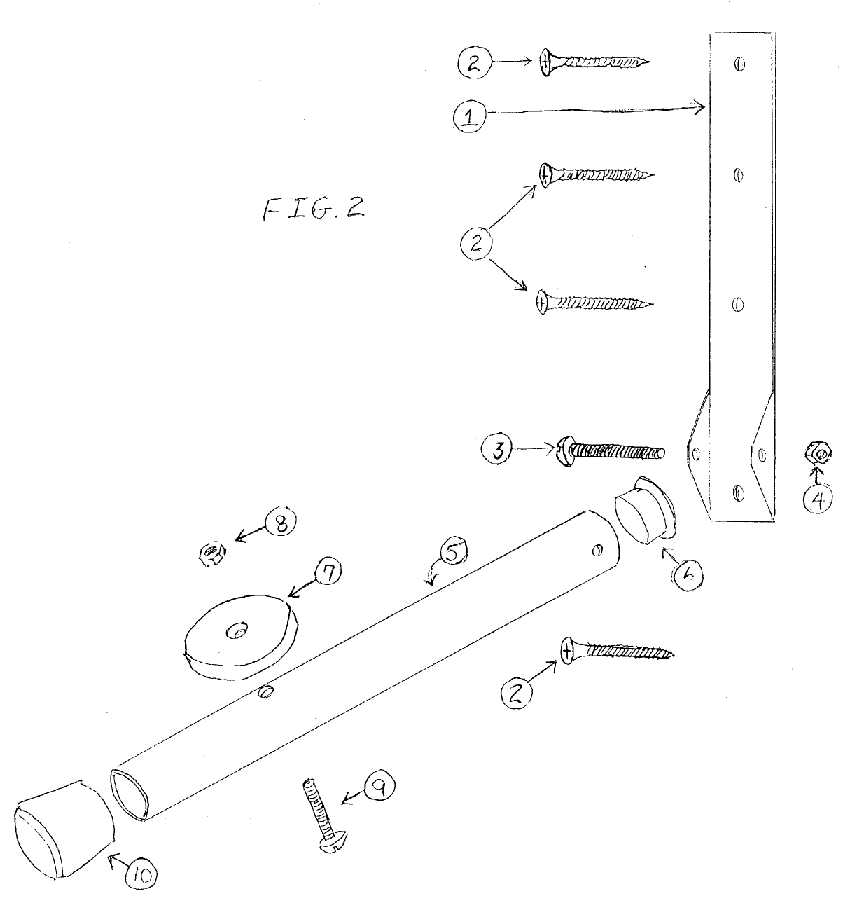

IN FIG. 2 The Gate-Mate device mounting bracket (1), that the pivot rod (5), is held on to the mounting bracket (1), by a bolt (3), and secured with a nut (4), the pivot rod (5), has a end plug (6) on the mounted end of the pivot rod (5), the opposite end of the pivot rod (5), has a rubber end cap (10), the pivot rod (5),has a magnet (7), attached by a bolt (9), and secured with a nut (8), when the Gate-Mate device is assembled it is then secured to a gate with the four mounting screws (2).

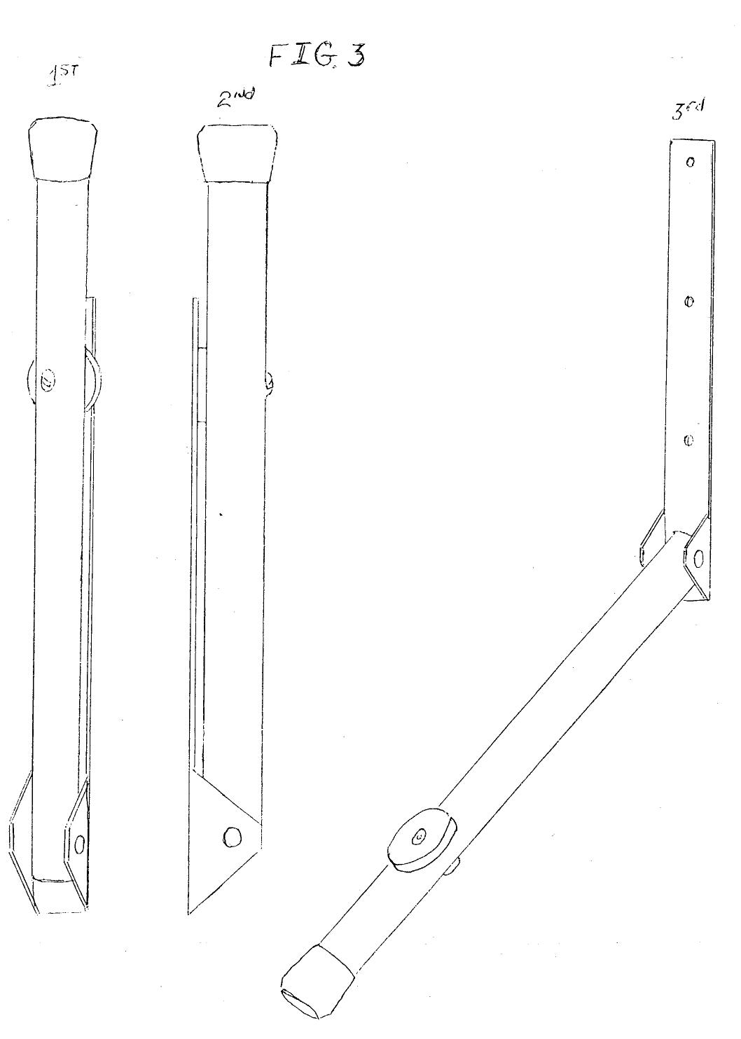

IN FIG. 3 This shows three different angles of the Gate-Mate device. The first (1^{st}) view shows the Gate-Mate device from the front as it would appear attached to a gate, but not in use, secured with the magnet (7), to the mounting bracket (1). The second (2^{nd}) view shows the Gate-Mate device from the side as it would appear attached to a gate, but not in use, secured with a magnet (7), to the mounting bracket (1). The third (3^{rd}) view shows the Gate-Mate device from the front as it would appear attached to a gate, and in use with the magnet (7), detached from the mounting bracket (1), permitting the pivot rod (5), to swing downward into the open position creating contact with the ground or other surface thus securing the gate permitting it to remain in an open position, and not permitting unwanted closure.

We claim

1. A gate stop system comprising, in combination:
a support in a rectangular flat configuration with long side edges, and short front, and back edges;
two sides in general trapezoidal configuration wherein said rectangular flat configuration support comprising the exterior portion;
a mechanism comprising a tubular configuration having coverings for opposing ends of said tubular configuration, having a circular releasable coupling device, having a multiple part fastening device on said circular releasable device attaching to said tubular configuration wherein said tubular mechanism comprising the interior portion;
means for attaching said rectangular flat configuration at said point of trapezoidal configuration to said tubular configuration comprising multiple part fastening apparatus;
means for attaching said rectangular flat configuration to a gate comprises numerous single part fastening apparatus or numerous multiple part fastening apparatus.

2. A gate stop system in accordance with claim 1 wherein said rectangular flat configuration comprises a smooth material.

3. The gate stop system in accordance with claim 1 wherein said tubular configuration comprises a smooth material.

4. The gate stop system in accordance with claim 1 wherein said circular releasable coupling device comprises a smooth material.

5. The gate stop system in accordance with claim 1 wherein said multiple part fastening apparatus comprises a rigid material plus a smooth material.

6. The gate stop system in accordance with claim 1 wherein said numerous single part fastening apparatus comprises a rigid material.

7. The gate stop system in accordance with claim 1 wherein said rectangular flat configuration is of a predetermined proportionate size to provide a supporting means for said tubular configuration.

8. The gate stop system in accordance with claim 1 wherein said tubular mechanism is comprising various measurements to provide a retaining means for a gate.
